(19) United States
(12) Patent Application Publication
(10) Pub. No.: US 2011/0128471 A1
(43) Pub. Date: Jun. 2, 2011

(54) ILLUMINATION PANEL AND DISPLAY

(76) Inventors: James Rowland Suckling, Oxford (GB); Tong Zhang, Oxford (GB); David James Montgomery, Oxford (GB)

(21) Appl. No.: 13/002,527

(22) PCT Filed: Jul. 7, 2009
(86) PCT No.: PCT/JP2009/062644

§ 371 Date: Jan. 4, 2011

(30) Foreign Application Priority Data
Jul. 7, 2008 (GB) 0812373.9

(51) Int. Cl. G02F 1/1335; F21V 7/22

(52) U.S. Cl. 349/62; 362/606

(57) ABSTRACT

An illumination panel is provided, for example for use as a backlight for illuminating an at least partially transmissive display (1). The panel comprises a light source (18), for example in the form of a light emitting diode which emits light in a relatively narrow waveband. A light guide (3) receives the light from an edge surface and guides light by total internal reflection. Combined light extraction and phosphor elements (19) on at least one of the major surfaces of the light guide (3) permit extraction of the light but also convert at least some of the light from the light source (18) to a different visible waveband. By locating the combined phosphor and extraction features at least partially inside the lightguide (3) it is possible to control the angular distribution of the extracted light and, in particular, to arrange for the variation of intensity with angle of light extracted without wavelength conversion to be substantially the same as the variation of intensity with angle of light emitted with wavelength conversion.

### TECHNICAL FIELD

The present invention relates to a distributed illumination panel that may be used as a backlight, for example for use with an at least partially transmissive spatial light modulator, or that may be used for general illumination. The present invention also relates to a display including such a backlight.

### BACKGROUND ART

The following prior art utilises a light modulating layer, such as a liquid crystal display to control the irradiation of phosphors, and hence the colour of each pixel:

In U.S. Pat. No. 7,248,310 (Philips Lumileds Lighting Company) a colour, transmissive liquid crystal display (LCD) uses a backlight that supplies a uniform blue light to the back of the liquid crystal layer in an LCD. The blue light, after being modulated by the liquid crystal layer, is then incident on the back surface of a phosphor material located above the liquid crystal layer. A first phosphor material, when irradiated with blue light, generates red light for the red pixel areas of the display. A second phosphor material, when irradiated by blue light, generates green light for the green pixel areas of the display. No phosphor is deposited above the blue pixel areas.

In U.S. Pat. No. 5,608,554 (Samsung), a display device, including a backlight source with an emission peak between 380-420 nm, controls the irradiation of red, green and blue coloured phosphors located at the front of the display, by transmission of the light through a light modulating layer, such as a liquid crystal panel.

In U.S. Pat. No. 6,654,079 (Koninklijke Philips Electronics), a display device includes a backlight having a main emission peak below 360 nm. Irradiance of red, green and blue phosphors located in front of the display is controlled by the transmission of light through an electro-optic device (such as a liquid crystal panel).

In U.S. Pat. No. 5,629,783 (Casio), a display device include a polymer dispersed liquid crystal layer that may be used to in either a transmissive or reflective display in conjunction with colour phosphors on either the upper or lower substrate to achieve a colour display. No light source is specified.

In U.S. Pat. No. 6,844,903 (Lumileds Lighting U.S.) a display device includes a liquid crystal panel backlit by blue light distributed by a light guide arrangement. The blue light is controlled by a liquid crystal panel. The same light may then irradiate red or green phosphors in front of the display located above the appropriate sub-pixels. No phosphor is present in front of the blue sub-pixel.

In WO 97/07426 (A. Cupolo), an emissive liquid crystal display has a backlight and a liquid crystal cell for modulating the light. A phosphor layer coated on the light exiting side of the display panel receives the modulated light and converts it into longer wavelengths. The phosphor layer may contain just red and green phosphors, with blue light being injected into the lightguide, or the phosphor may contain red, green and blue phosphors based on near-ultraviolet light injected into the lightguide. The following prior art utilizes the phosphor between the light source and a light modulating layer to generate colour:

In U.S. Pat. No. 6,683,659 (Koninklijke Philips Electronics), a liquid crystal layer between two clear substrates, has at least one colour of phosphor arranged as dots on the back surface. This surface and a yet lower surface form a gastight gas discharge vessel that may be used to illuminate the phosphors. Transmission of the light emitted by the phosphors is controlled by the liquid crystal layer.

In U.S. Pat. No. 6,791,636 (Lumileds Lighting U.S.) a liquid crystal display has a lightguide backlight into which blue light is optically coupled on one or more sides. Red and green phosphors are located above the lightguide, coinciding with the red and green pixel areas of the display. Deformities below the red and green phosphor strips and the blue pixel areas direct blue light onto the backs of the phosphors and the blue pixel areas. If an ultraviolet light source is used, then blue phosphors would need to be used below the blue pixel areas.

In U.S. Pat. No. 6,809,781 (General Electric Company) a liquid crystal display utilizes at least one phosphor positioned between the panel and the backlight source to emit light in the wavelength ranges of colour filters. The backlight source may be a semiconductor light-emitting diode or an organic light-emitting device.

The above prior art all collectively require that a lightguide is used to distribute the light, upon which it is scattered out and then through the phosphor, located either above or below a light modulating layer. The final two use the phosphor, which makes contact with the lightguide, to extract the irradiating light:

In U.S. Pat. No. 5,396,406 (Display Technology Industries), a backlight for a display device may be formed from a lightguiding structure through which ultra-violet light is distributed. Phosphor strips make contact with the lightguide and provide both means for colour conversion and out-coupling from the lightguide. A micro-collimator mirror partially collimates the light emitted from the phosphor and an array of cylindrical lenslets focuses that light onto the display pixels.

JP-A-07-176 794 (Nichia) describes the use of a backlight formed from a lightguide, into which is coupled blue light from an LED, but whereby the scattering features usually present are replaced by yellow phosphor printed directly onto the lightguide itself. This printed phosphor acts both as out-coupling features and the means to convert blue light into white. The light extracted from the lightguide is then directed through the back of a liquid crystal panel as with many other backlight units.

FIG. 1 of the accompanying drawings illustrates the stack structure of a typical liquid crystal display (LCD) module. The module has a display denoted generally as 1. The detailed construction of the display 1 is not shown in FIG. 1, but it typically comprises a flat transmissive spatial light modulator (SLM) in the form of a LCD panel having input and output polarisers on its bottom and top sides. The rest of the structure is generally regarded as the backlight system, as follows. A light source 2 emits light, which is coupled into a lightguide 3, and distributed across the back of the display by way of total internal reflection (TIR) within the lightguide in such a way that if no scattering structures were present the light would travel until it reached the end of the lightguide 3. However, on the face of the lightguide 3, there are multiple light scattering structures 4 that extract the light from the lightguide 3 to illuminate the LCD panel 1. The density of the light scattering features 4 may increase with distance from the light source 2 to maintain a uniform rate of extraction of the light along the length of the lightguide 3. As light is extracted both down and up from the lightguide 3, a reflecting film 5 is placed beneath the lightguide 3 to improve the efficiency of the backlight. There are also some optical films 6 between the lightguide 3 and the LCD panel 1, placed to give better illumination uniformity over the display area and to enhance brightness within a given viewing angle range. The nature of these optical films 6 is well known and will not be described further here.

For a full colour LCD panel with red, green and blue sub-pixels and a white light source, the light travels through the lightguide, is scattered out to pass through the optical films and the absorptive red, green and blue filters beneath the appropriate sub-pixels, allowing the reproduction of full colour images. Currently, for small display applications, a white light emitting diode (LED) is often used. Most of the current small white LEDs consist of a semiconductor chip, 7, emitting light in the blue region of the spectrum in a reflective cup, 8, which is filled with a resin holding a suspension of yellow phosphor particles, 9. The yellow phosphor absorbs some of the blue light and re-emits it as yellow light, the combination of the two spectra giving a perceived white colour.

For the yellow phosphor white LED, in order to ensure that enough blue is converted to yellow, a certain amount of phosphor is required in the LED reflective cup. This will enlarge the final dimension of the LED. Enlarging the light source usually means decreasing the quality of the emitted light, which can be a problem when considering the construction of thin backlight systems. Furthermore, covering the LED in a phosphor loaded resin will reduce the thermal conductivity, reducing the dissipation of heat energy, which is created as a by-product of light emission from the blue LED chip. This means that the chip may not be driven to the optimal level to achieve best output of light.

The prior art backlight of JP-A-07-176 794 uses a phosphor medium, for example a phosphor-loaded resin, located outside the immediate proximity of the light source, as shown in FIG. 2—in FIG. 2 the phosphor medium is not disposed in the LED cup 8, but is instead disposed in or on the light guide 3 (as described in more detail below). The phosphor in the resin converts short wavelength light (such as UV or blue light) into longer wavelength light (such green, yellow, red etc). By controlling the amount of phosphor so that not all of the original light is absorbed, it is possible to create a mix of the two spectra, allowing for the creation of other perceived colours, particularly white. In this or similar prior art where the phosphor loaded resin (herein referred to as phosphor medium) extraction dots have been located on one of the major surfaces of the lightguide, either the top or bottom, the top surface being defined as the surface of the lightguide presented to the user of the display, extraction of light may occur at the location of the phosphor medium. Extractions features of this nature are shown as 10 in FIG. 2, with the shading in FIG. 2 indicating the phosphor medium. The extraction of the light occurs via three methods: a) (FIG. 3) transmission of the short wavelength light, 11, from the lightguide into the phosphor medium, 10, then absorption of the light by the phosphor itself, with subsequent re-emission at longer wavelengths, 12, and over a generally wider angular distribution, b) (FIG. 4) reflection and refraction at the air/resin interface of the resin dot, 13 (as opposed to lightguide/resin, 14), giving rise to an extracted short wavelength light beam at well defined angles, 15 and c) (FIG. 5) transmission of short wavelength light into the phosphor medium with subsequent scattering of the short wavelength light from the phosphor particles themselves, without conversion to longer wavelength, 16. Method c) makes a smaller contribution to the extraction of short wavelength light than method b). Method b) is the broadly the same extraction mechanism as a typical extraction feature, usually made from bumps in, or on, the lightguide surface, and of the same material as the lightguide. Extraction of light from a conventional lightguide also results in a well defined beam of light at a specific angle.

The above extraction method (the combination of a, b and c) has a disadvantage that the two colour components of the extracted light have different angular distributions. The angular distribution of the blue and yellow light are shown in FIGS. 6 and 7 respectively. The spike in the extracted blue light is shown to occur at ˜65, 17, FIG. 6.

As the colour is determined by the blue/yellow relative ratio, the blue peak would mean that there would be significant colour variation, especially at high angle without very significant diffusion. This is undesirable for both backlighting applications and general illumination systems.

A number of other systems similar to that of JP-A-07-176 794 are known. For example WO2004/099664 discloses a light source having a waveguide plate that is formed of a film that contains phosphors and that is disposed between two light guide plates. JP 2003-036714 discloses a light guide plate having a fluorescent material disposed in a recess formed in a face of the light guide plate. JP 2002-116325 discloses a light source having a light guide plate that is formed of a translucent material that contains a dichroic fluorescent substance.

### SUMMARY OF INVENTION

A first aspect of the present invention provides an illumination panel comprising at least one light source arranged to emit light in at least one first waveband; a lightguide having first and second facing major surfaces, the first of which comprises an output surface for light, and a minor edge surface through which at least one light source is arranged to introduce light into the lightguide; and a plurality of combined light extraction and phosphor elements disposed at least partially between the first and second major surfaces and arranged to cause extraction of light in the waveguide through the output surface and to emit light in at least one visible second waveband, different from the at least one first waveband, when excited by light in the at least one first waveband. The combined elements are arranged to cause extraction of light of the first waveband with a first (angle-dependent) distribution of intensity and to emit light of the second waveband with a second (angle-dependent) distribution of intensity, the variation with angle of the second distribution of intensity being equal or substantially equal to the variation with angle of the first distribution of intensity.

Light propagates within the lightguide by total internal reflection (TIR) until it is incident on a combined light extraction and phosphor element when it may be extracted from the lightguide without a change in wavelength or it may undergo wavelength conversion and be emitted from the light guide at a new wavelength. By locating the combined extraction and phosphor elements at least partially inside the lightguide it is possible to control the angular distribution of the intensity of the extracted light.

Specifying that the combined light extraction and phosphor elements emit light “in at least one visible second waveband” is intended to cover both the case where the combined light extraction and phosphor elements emit substantially monochromatic light within the second wavelength band and the case where the combined light extraction and phosphor elements emit light at two or more wavelengths that combine to give light that appears to an observer to be within the second waveband.

As explained above, the prior art light sources have the disadvantage that the colour of the emitted light is dependent on the output angle of the light, owing to the spike in intensity of the extracted short wavelength (eg blue) light shown in FIG. 6, which is undesirable for many applications and so requires the use of additional optical components to correct for the angular distribution of the colour of the emitted light. The present invention addresses this problem by making the variation, with angle, of the intensity of extracted light of the first waveband (hereinafter referred to as the “first angular distribution” for convenience) equal or substantially equal to the variation, with angle, of intensity of emitted light of the second waveband (hereinafter referred to as the “second angular distribution” for convenience), so that the colour of the overall light output does not vary significantly with output angle—so that the need for additional optical components to correct for variation with angle of the colour of the emitted light is reduced or eliminated. This is achieved by changing the mechanism for extraction of the short wavelength light, so that the short wavelength light is extracted by, or is extracted predominantly by, the scattering mechanism of FIG. 5 rather than by the reflection and refraction mechanism of FIG. 4.

Preferably the difference between the “first angular distribution” and the “second angular distribution” is sufficiently small that the intended receptor of the output from the light source (for example the human eye or a light sensor) perceives little or no variation with angle in the colour of the overall light output, so that it is not necessary to provide optical components specifically to correct for variation with angle of the colour of the emitted light.

It should be noted that specifying that the “first angular distribution” is equal or substantially equal to the “second angular distribution” does not require that, for a given angle, the output intensity of light of the first waveband is equal in magnitude to the output intensity of light of the second waveband. What is important is that the relative ratio between the magnitude of the output intensity of light of the first waveband and the magnitude of the output intensity of light of the second waveband does not vary significantly with angle, so that the user does not perceive any significant variation with angle in the colour of the output light. Provided that this is achieved, the output intensity of light of the first waveband relative to the output intensity of light of the second waveband may be chosen to give a desired colour for the output light.

The combined elements may be disposed in respective recesses in one major face of the lightguide. The term “recess” as used herein is intended to cover features such as a “groove”, “cavity”, “indent”, etc. Specifying that the combined elements may be disposed in respective recesses in “one” major face of the lightguide is not intended to exclude the possibility that, if desired, combined elements may be disposed in respective recesses in both major faces of the lightguide.

The cross-section of the recesses (as seen in a sectional view through the lightguide) may be a portion of an ellipse. It may be half of an ellipse, with the edges of the recess intersecting the one major face of the lightguide at substantially 90. Alternatively, the cross-section of the recesses may be rectangular, triangular, etc. A term “cross-section” refers to a cross section which is perpendicular to the first major surface, the second major surface, and the minor edge surface.

The surface of a combined element may be co-planar or continuous with the one of the first and second major surfaces of the light guide in which the combined element is provided. This minimises or even eliminates light extraction by method b) of FIG. 4. Preferably, the surface of each combined element may be co-planar or continuous with the one of the first and second major surfaces of the light guide in which the combined element is provided.

Alternatively, the surface of one or more of the combined element may protrude beyond the one major face of the lightguide. In this case, the surface of a combined element may have a planar portion.

Alternatively, the combined elements may be disposed within the lightguide, such that they are spaced from both the first and second surfaces of the lightguide. They may be disposed within the respective cavities within the lightguide. They may have an elliptical cross-section (as seen in a sectional view through the lightguide). Alternatively, the cross-section of the recesses may be rectangular, triangular, etc.

Light from the output surface may be arranged to appear white. The at least one first waveband may comprise at least one visible first waveband. The at least one visible first waveband may comprise a single colour, for example blue.

The at least one visible second waveband may be yellow.

The combined elements may comprise first and second sets arranged to emit red and green light, respectively, when respectively excited by yellow light and blue light. Again, the first (second) set of combined elements may emit substantially monochromatic light within the red (green) wavelength band or they may emit light at two or more wavelengths that combine to give light that appears red (green).

The at least one light source may comprise at least one blue or ultraviolet source and the combined elements may comprise first, second and third sets arranged to emit blue, green and red light when excited by ultraviolet or blue light, respectively. Again, each set of combined elements may emit substantially monochromatic light within its wavelength band or may emit light at two or more wavelengths that combine to give light that appears to be within its wavelength band.

The at least one light source may comprise at least one light-emitting diode or at least one semiconductor laser or gas discharge vessel.

The illumination panel may comprise a reflector facing the second major surface.

A second aspect of the present invention provides a display comprising an illumination panel of the first aspect disposed behind an at least partially transmissive spatial light modulator. By “disposed behind” is meant that the illumination panel is disposed on the opposite side of the spatial light modulator to an observer so as to act as a backlight.

The spatial light modulator may be a liquid crystal display.

Preferred embodiments of the present invention will be described by way of illustrative example, with references to the accompanying drawings.

### BRIEF DESCRIPTION OF DRAWINGS

FIG. 1 shows a typical known liquid crystal display (LCD) module.

FIG. 2 shows a display with a backlight having a phosphor medium located on the outside back surface of the lightguide, in place of the original scattering features.

FIG. 3 shows extraction of blue light from a lightguide by absorption into the phosphor and re-emission at longer wavelength over a wide angular distribution.

FIG. 4 shows extraction of blue light from the lightguide into specific angles by refraction and reflection from the air/resin interface of the printed remote phosphor dot.

FIG. 5 shows extraction of blue light from the lightguide by scattering by the phosphor particles into a wide angular distribution.

FIG. 6 shows the angular distribution of the blue light as extracted from a lightguide using the remote phosphor arrangement as described in prior art, shown in FIG. 2.

FIG. 7 shows the angular distribution of the yellow light extracted from a lightguide using the remote phosphor arrangement as described in prior art, shown in FIG. 2.

FIG. 8 shows the angular distribution of blue light as extracted from a lightguide using the remote phosphor arrangement as described in the current invention.

FIG. 9 shows a display with a backlight constituting an embodiment of the invention with the remote phosphor extraction features embedded into the bottom major surface the lightguide.

FIG. 10 shows the preferred shape of a phosphor extraction feature of FIG. 9, in which the sides of the tube are shown to intersect the bottom major surface of the lightguide at 90 and the lower surface of the phosphor medium is shown to be substantially co-planar with the major surface of the lightguide.

FIG. 11 shows a display with a backlight constituting a further embodiment of the invention with the remote phosphor extraction features embedded into the top major surface of a lightguide.

FIG. 12 shows a display with a backlight constituting another embodiment of the invention with the remote phosphor extraction features embedded fully into the lightguide between the top and bottom major surfaces of the lightguide.

FIG. 13 shows a display with a backlight constituting a further embodiment of the invention with the remote phosphor extraction features embedded partially into both major surfaces of the lightguide. The phosphor features are shown in random alignment.

FIG. 14 shows a lightguide with remote phosphor extraction features aligned vertically between the top and bottom major surfaces. The extraction features are shown in random positions and do not indicate a preferred arrangement.

FIG. 15 shows a lightguide with remote phosphor extraction features aligned to an arbitrary angle in the plane orientated perpendicular to the net propagation direction of the light within the lightguide.

FIG. 16 shows a lightguide with remote phosphor extraction features orientated in the same direction as those described in the preferred embodiment. The extraction features are divided into sections, which are longer than wide, 29 and 30 respectively.

FIG. 17 shows a lightguide with remote phosphor extraction features orientated to an arbitrary angle in a plane perpendicular to the net propagation direction of the light within the lightguide, FIG. 15. The extraction features are cut into sections such that only some terminate at the top major surface of the lightguide.

FIG. 18 shows a display with a backlight constituting a further embodiment of the invention with the remote phosphor extraction features embedded partially into the bottom major surface of the lightguide, but with some protrusion into the air gap between the lightguide and the reflective film, 5.

FIG. 19 shows a display with a backlight constituting a further embodiment of the invention with different remote phosphors suspended in a resin dot pattern providing multiple wavelength output peaks.

FIG. 20 shows a display with a backlight constituting another embodiment of the invention with the remote phosphor extraction features located in different shaped indents; square, 34 or triangular, 35, amongst other possibilities.

FIG. 21 shows the CIE 1931 colour chart.

### DESCRIPTION OF EMBODIMENTS

The illumination panel of the present invention will be described with particular reference to a backlight for use with a display having an at least partially transmissive spatial light modulator. The illumination panel of the invention is not however limited to this use.

One feature of the invention is the re-location of the phosphor medium extraction features of an illumination system similar to that of FIG. 2 from outside either of the major lightguide surfaces to be partially, or wholly, between these surfaces. The location may be entirely between the two surfaces, such that the extraction features are fully surrounded by the material of the lightguide, or partially between the surfaces so that there is a portion of the phosphor medium extraction feature that has an air/resin interface. An example of shape may be a half tube with elliptical cross section, made into the bottom major surface of the lightguide. This can then be entirely filled with a phosphor medium (e.g., a yellow phosphor medium) such that the resin surface is flat and flush with the bottom surface of the lightguide. This shape will be discussed below.

It should be noted that a “yellow phosphor medium” refers to a phosphor medium which, when illuminated with light of a suitable wavelength, emits light that appears to be in the yellow region of the spectrum. A “yellow phosphor medium” may emit light at a single wavelength in the yellow region of the spectrum, or it may emit light at two or more different wavelengths such that the overall output of the phosphor medium appears yellow to an observer. Terms such as “red phosphor” or “green phosphor” etc. have analogous meanings. The light perceived by an observer when a phosphor medium is illuminated will, in general, contain a component emitted by the phosphor medium and a component corresponding to the part of the illuminating light that is not absorbed by the phosphor medium (provided that the illuminating light is in the visible spectral region). As an example an excited phosphor medium may emit light that appears to be in the yellow spectral region and so the output light may, if the unabsorbed illuminating blue light can be ignored, also appear yellow. Where two or more different colour phosphors are provided, the overall light output perceived by an observer will, in general, contain components emitted by each phosphor and a component corresponding to the unabsorbed part of the illuminating light, so that the overall light output may appear different from the individual phosphors. For example, red and green phosphors may emit light that appears to be red and green respectively, but the combined output may appear yellow.

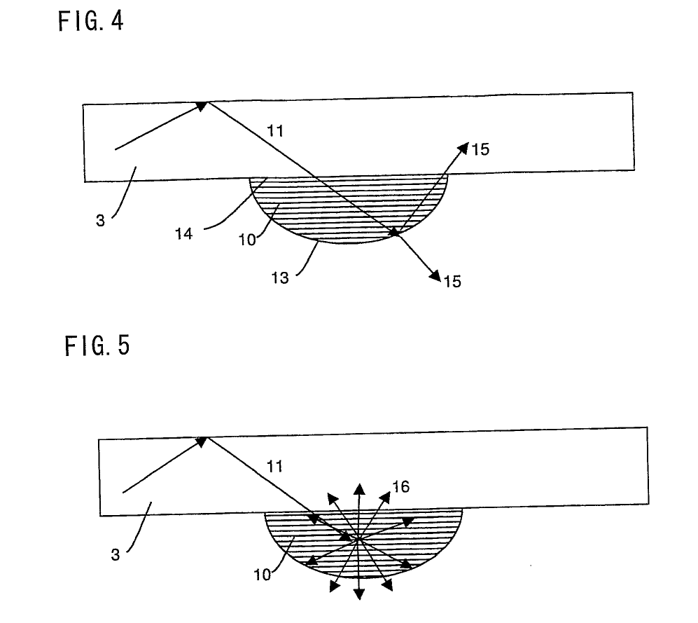

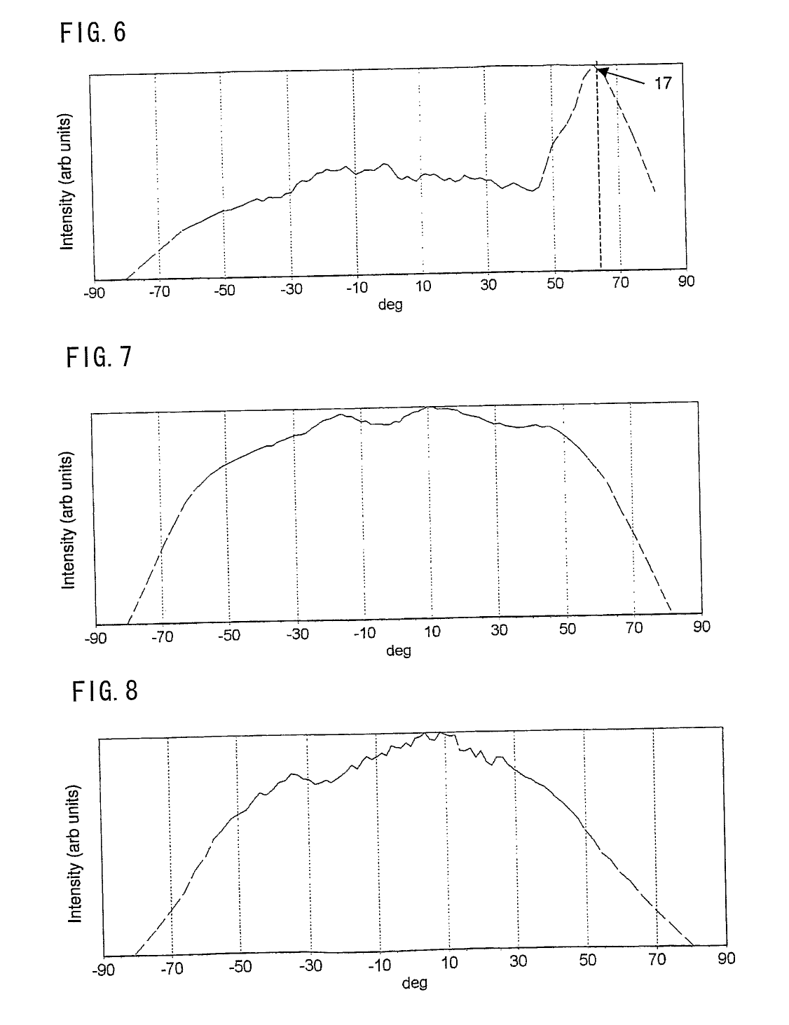

The creation and extraction of the longer wavelength light is by absorption of the short wavelength light by the phosphor particles and re-emission of that light at longer wavelength. However, the advantage of the current invention is the swap in relative importance of the extraction methods of the short wavelength light. Whereas in prior art the short wavelength light is extracted primarily by interaction with the resin/air interface (method b, FIG. 4) and less so by scattering from the phosphors (method c, FIG. 5) the opposite is now true in the invention. Extraction of short wavelength light occurs predominantly via scattering from the phosphor particles (method c). Indeed, extraction by method b is eliminated altogether if the bottom surface of the resin is flat and flush with the major surface of the lightguide. This may be termed “co-planar”. The change in relative importance of light extraction methods makes the phosphor the source of both the short and long wavelength light. Furthermore, as both primary mechanisms cause extraction of the light into a generally isotropic angular distribution there is no longer the well defined beam at a particular angle associated with the short wavelength, as shown in FIG. 6 (reference 17). The similar angular distribution of the two wavelength spectra is an advantage for the use of the illumination panel in either a display backlight or general lighting as it reduces the number, or strength, of the correction films required to shape the light into a desirable angular colour distribution. With a lower diffusion requirement, high on-axis brightnesses are possible with such an arrangement using, for example, brightness enhancement films. The extracted intensity distribution, as a function of output angle, of blue light for this invention is shown in FIG. 8. It can be seen that the intensity distribution of FIG. 8 is considerably modified compared to the intensity distribution, as a function of output angle, for blue light shown in FIG. 6. It can also be seen that the intensity distribution of FIG. 8 is similar to the intensity distribution, as a function of output angle, of yellow light shown in FIG. 7.

The similarity in the extraction mechanisms of both the short and the long wavelength components of the light has the extra advantage that the perceived source of both wavelength spectra is in the same location. This is an advantage over the prior art, where the well-defined beam in the short wavelength has to be redistributed over a wider angle range by optical films located above the lightguide. By this prior art method, the two spectra appear to come from different locations, leading to the possibility of perceived colour dislocation.

As explained above, the difference between the variation with angle of the intensity of short wavelength light scattered out of the light guide by method c (the “first angular distribution”) and the variation with angle of the intensity of longer wavelength light re-emitted from of the light guide by the phosphors by method a (the “second angular distribution”) is preferably sufficiently small that the intended receiver of the output from the light source (for example the human eye or other light sensor) perceives little or no variation with angle in the colour of the overall light output from the light guide. By providing for the colour of the overall light output as perceived by the user to be the same at all angles the invention provides a significant improvement over the prior art. As explained, the prior art light source would show a distinct change in colour towards the blue region of the spectrum (in the two-component blue/yellow example) at a certain angle.

More formally, the difference between the variation with angle of the intensity of short wavelength light scattered out of the light guide by method c (the “first angular distribution”) and the variation with angle of the intensity of longer wavelength light re-emitted from of the light guide by the phosphors by method a (the “second angular distribution”) should be small enough that the colour of the overall light output does not vary by more than a set range of values over all angles of emission. This is what is meant by stating the variation with angle of the output intensity for the two wavelength bands (eg. the angular variations of output intensity in the graphs of FIGS. 7 and 8) should be “substantially equal”.

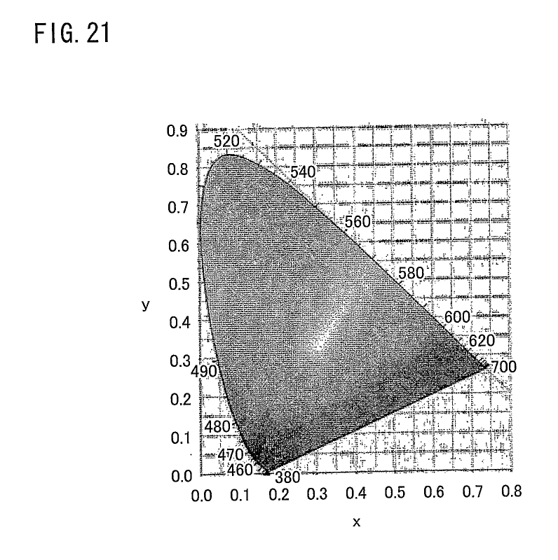

FIG. 21 shows the CIE 1931 colour chart. Changes in x and y on the CIE 1931 colour chart define a change in colour. The position of white on this chart is taken to be in the region of y=0.33 and x=0.33, where x and y are the CIE parameters defining the chromaticity.

A shift in colour of Δx=0.05 and Δy=0.05 on the CIE 1931 colour chart may give a change in colour that is perceptible to the human eye, and a shift in colour of Δx=0.075 and Δy=0.075 on the CIE 1931 colour chart would give a change in colour that would almost certainly be perceptible to the human eye. In the case of a light source intended for viewing by the human eye, therefore, the difference between the variation with angle of the intensity of short wavelength light scattered out of the light guide by method c (the “first angular distribution”) and the variation with angle of the intensity of longer wavelength light re-emitted from of the light guide by the phosphors by method a (the “second angular distribution”) is preferably small enough that the shift in the colour of the overall light output over the angular range is less than Δx=0.075 and Δy=0.075 on the CIE 1931 colour chart, and is preferably less than Δx=0.05 and Δy=0.05 on the CIE 1931 colour chart. Ideally this requirement would be met over the entire angular range from −90° to 90°. However, many applications do not require viewing angles of up to −90° or 90°, and in most if not all practical cases it will be sufficient if the requirement is met over the angular range from −85° to 85° or even over the angular range from −80° to 80°.

As noted above, the relative magnitudes of the intensities in the first and second wavebands may be chosen to give a desired colour for the overall output.

The current invention has the further advantage that location of the phosphor medium may be inside indents cut into a major surface of the lightguide, allowing for accurate shape definition and location of the extraction features. This may be more well-controlled than in the prior art arrangement which would rely on either the surface tension of the resin or a separate step in the process to define the shape.

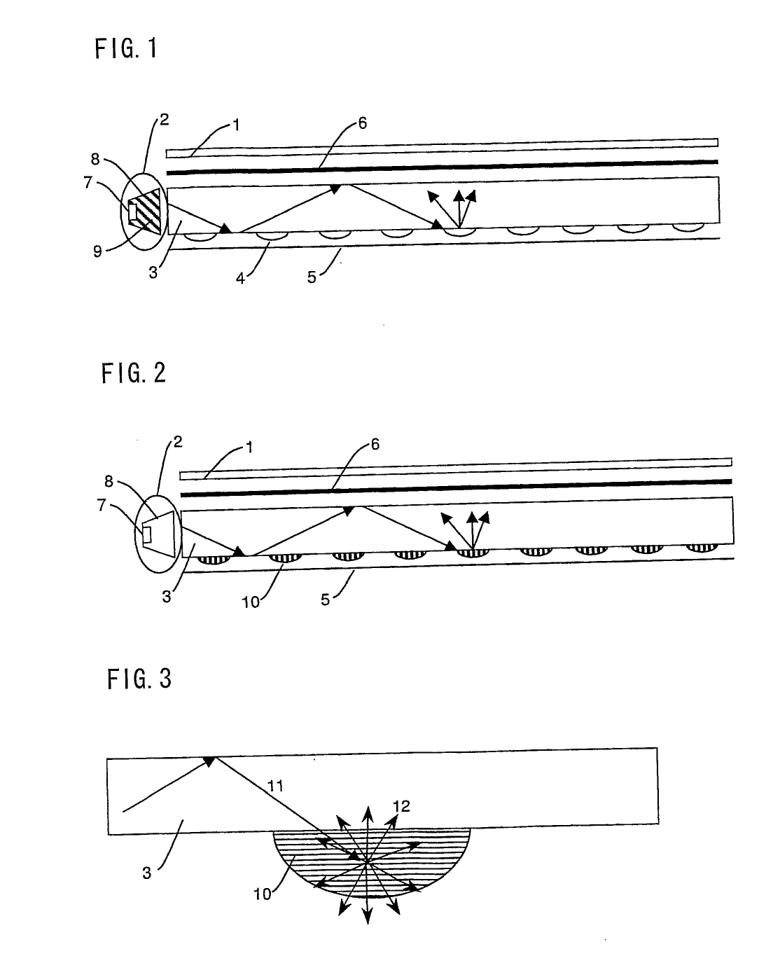

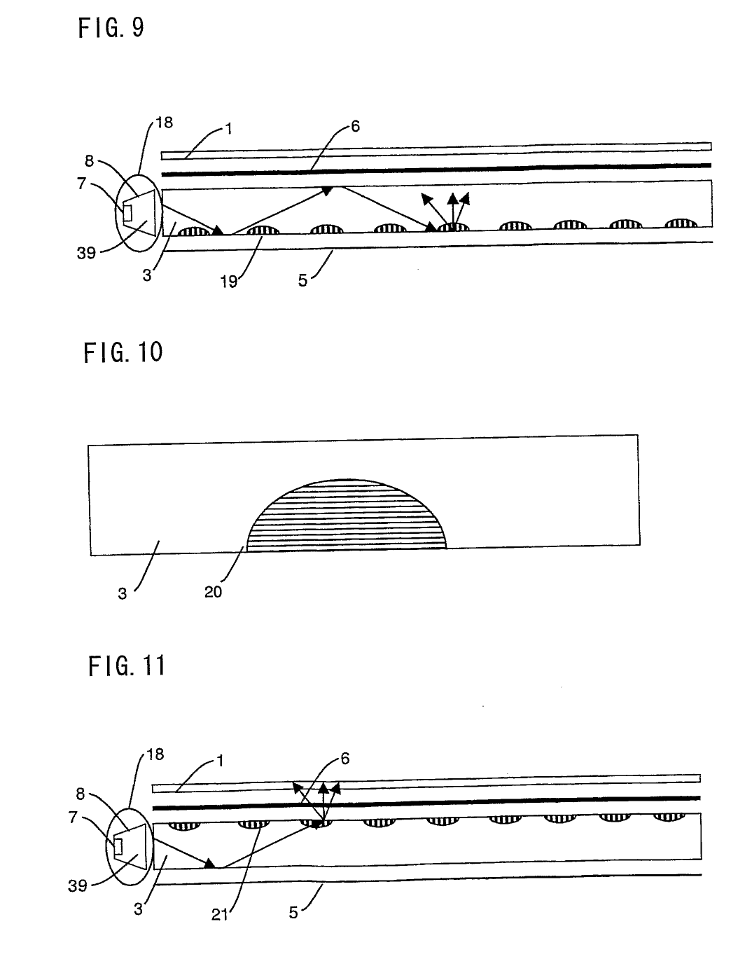

FIG. 9 shows a display with a backlight (illumination panel) which differs from that shown in FIG. 1 in that it uses a remote phosphor (phosphor medium), outside the LED cup (the reflective cup 8). The display comprises an at least partially transmissive spatial light modulator 1, for example an LCD panel. The backlight is disposed behind the spatial light modulator. When the phosphor is excited by light in the blue region (first waveband), the phosphor may emit light at a single visible output wavelength (second waveband) peak to give monochromatic output light which is different from the light in the blue region, or it may emit light at two or more visible wavelengths which combine to give light with the appearance of the same colour as the monochromatic output light of the second waveband. A blue LED 18 is used as a light source. The blue LED 18 consists of a semiconductor chip 7, for emitting light in the blue region (first waveband) of the spectrum, provided in the reflective cup 8. In contrast to the LED of FIG. 1, the LED cup does not contain a phosphor so that the light from the LED chip 7 is emitted from the LED 18 without significant change in wavelength. The LED cup 8 may be filled with colorless gas 39 such as air, or may be filled with a transparent material 39 such as a transparent resin. The semiconductor chip 7 is arranged to introduce light through one of shorter minor edge surfaces (minor edge surfaces perpendicular to the plane of the paper in FIG. 9) of the lightguide 3 into the lightguide 3. The backlight may further include a reflecting film (reflector) 5 placed beneath the lightguide 3 and facing the bottom major surface of the lightguide 3, to reflect any light emitted in a downwards direction from the lightguide 3. The backlight may further include optical films 6 between the lightguide 3 and the LCD panel 1. The reflector 5 and the optical films are not part of the principal concept of this invention, and will not be described further.

Indents 19 or recesses are made in the bottom major surface of the lightguide 3 to receive a phosphor (for example a phosphor/resin mixture) to form combined light extraction and phosphor elements. In this embodiment the upper major surface (“first major surface”) of the lightguide 3 is the output surface and the recess 19 are made in the other major surface (ie in the “second major surface”) of the lightguide 3. The preferred shape (as seen in a sectional view through the lightguide 3) of the combined light extraction and phosphor elements is half of an elliptical tube (a tube, a cross section of which is half of an ellipse), the edges (sides) of which intersect the bottom major surface at 90 (20, FIG. 10). In this embodiment the external surface of at least one extraction feature (i.e., the external surface of a combined light extraction and phosphor element), as opposed to the surface (of the extraction feature) in contact with the material of the lightguide 3, is arranged so as to not protrude from the lightguide 3 and is preferably parallel and flush to the bottom major surface of the lightguide 3. Particularly preferably the external surface of every extraction feature is arranged so as to not protrude from the lightguide 3 and is preferably parallel and flush to the bottom major surface of the lightguide 3—so that the external surface of the extraction feature is co-planar, or substantially co-planar, with the bottom major surface of the lightguide 3 as also shown in FIG. 10. The indents 19 may be made to run the entire width of the lightguide 3 (i.e., into the plane of the paper in FIG. 9), so that its major axis is perpendicular to the net direction of the light propagation. The ends of the extraction feature will intersect the longer minor side (edge) surfaces (of the lightguide 3) running along the length of the lightguide 3. At this point the ends of the external surface of the extraction feature should be substantially co-planar to the longer minor side surface. This shape provides the best angular distribution of the blue light upon extraction and provides the greatest volume of phosphor with which the light may interact. As such the half tube is the shape that would be used for the indents 19 as the most common application. The shape used for the indents 19 changes the angle of incidence of the TIR light on the surface of the lightguide 3, as well as the surface condition, disrupting the TIR and allowing extraction of blue light from the lightguide 3 into the resin/phosphor. Part of the blue light is absorbed by the phosphor and is re-emitted as yellow light. The rest of the blue light is scattered by the phosphor particles. The overall result is that the yellow and blue light is extracted from the lightguide 3 through a light output surface of the lightguide 3 over a predetermined angle range and travels towards the LCD panel 1, which is illuminated with uniform, white light. As explained above, the angular distribution of intensity of extracted blue light is substantially equal to the angular distribution of intensity of extracted yellow light. The indents 19 may be formed by cutting or drilling into an otherwise flat surfaced lightguide, or created by using a shaped mould at the formation of the lightguide 3 itself. The indents 19 would then be filled with a yellow phosphor medium in a second step of the manufacturing process.

The refractive index of the phosphor/resin mixture may for example be matched or approximately matched to the refractive index of the lightguide material. This provides the optimal coupling of light into the phosphor medium.

The shape of the phosphor medium surface inside the lightguides 3 is not limited to the precise shape described in the preferred embodiment of FIGS. 9 and 10.

The remote phosphor pattern 21 may alternatively be located on the top major surface of the lightguide, FIG. 11. The light source 18 may be in the form of one or more LED chips, one or more (semiconductor) lasers, a gas discharge source, or any other light source with a limited number or range of wavelengths (this is true for all embodiments of the invention).

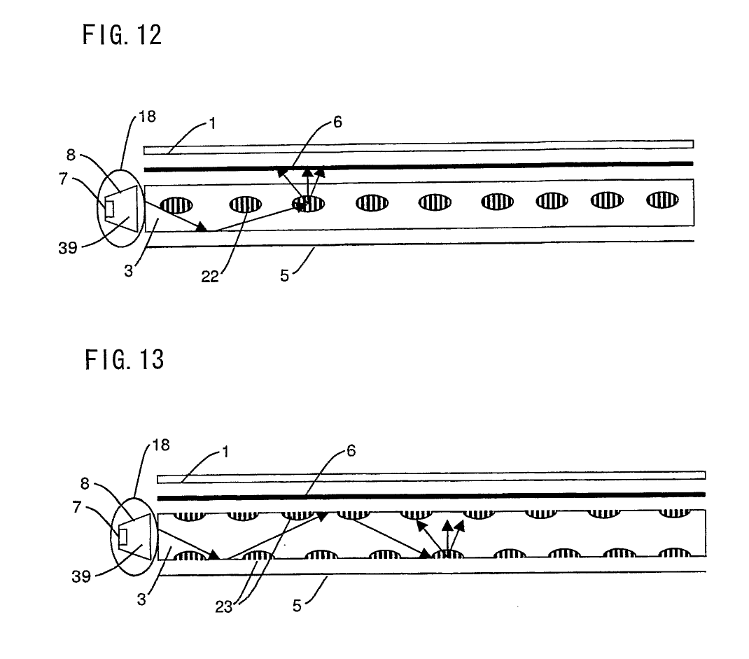

The phosphor medium 22 may be fully embedded inside (within) the lightguide 3, as shown in FIG. 12 for example in cavities in the lightguide 3. In this embodiment the cross-section of the phosphor medium, as seen in a cross-section through the lightguide 3 may be elliptical or substantially elliptical, although any other cross-section may be used such as, for example, rectangular or triangular. The embodiment of FIG. 12 may be manufactured using, for example, a known two-layer resin process.

As a further alternative the phosphor 23 may be located adjacent both major surfaces of the lightguide 3 simultaneously, as shown FIG. 13. It is not necessary for the phosphor features (combined light extraction and phosphor elements) adjacent one major surface of the lightguide 3 to be specifically aligned, or specially staggered, with the phosphor features adjacent the other major surface—the relative arrangement of the phosphor features adjacent the two major surfaces may be chosen to best suit a particular application or to obtain a particular brightness uniformity distribution.

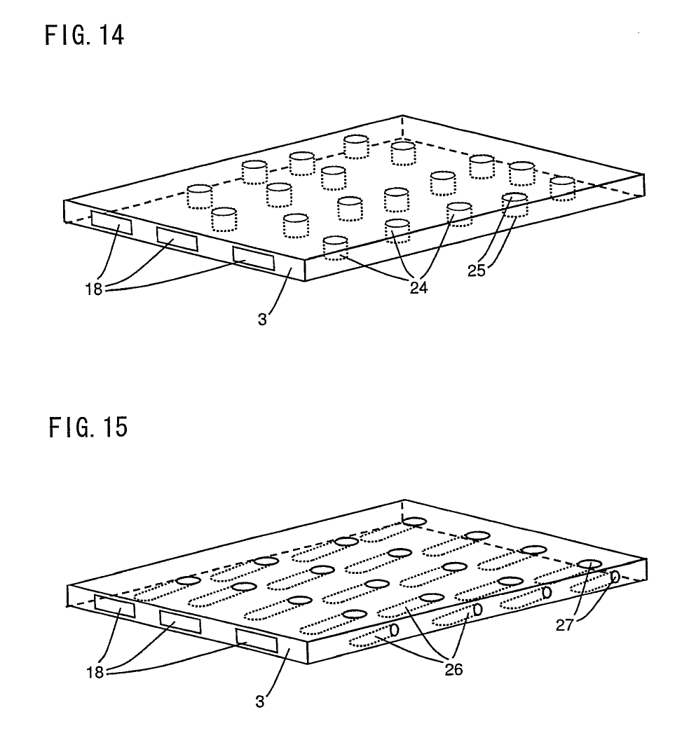

The phosphor extraction features (combined light extraction and phosphor elements) are not limited to the specific orientation of FIG. 9 and may for example be rotated in a plane perpendicular to the net direction of the light propagation and still satisfy the absorption and re-emission requirements for the provision of white light. FIG. 14 shows the phosphor/extraction features (combined light extraction and phosphor elements) 24 rotated to pass through the lightguide 3 from the top to the bottom major surfaces of the lightguide 3. The end faces 25 of the phosphor/extraction features (which have, in this embodiment, the form of a column) which have an air interface are preferably still maintained as substantially co-planar to the major surface of the lightguide. The LEDs, or light sources, are denoted by 18, but do not represent a particular arrangement or number to be used. The extraction features are shown in a random arrangement and do not denote a preferred pattern. The lightguide is shown without any of the ancillary optical films that are shown in FIG. 9, for example, to aid clarity.

The phosphor extraction features may be rotated to some other angle in the plane perpendicular to the light propagation direction. FIG. 15 shows the phosphor column rotated to a third angle 26 relative to the plane of the lightguide while still remaining perpendicular to the net direction of the light propagation. This angle may be arbitrary, between the limits of perpendicular or parallel to the major surface. Again the ends 27 of the extraction features with an air interface are preferably substantially co-planar to the surface of the light guide at which the extraction features terminate. The extraction features are highlighted as being shown to terminate at the top major surface and a minor side surface of the lightguide 3, but equally it could be the bottom or other side surface as the termination areas. The lightguide is shown without any of the ancillary optical films that are shown in FIG. 9, for example, to aid clarity.

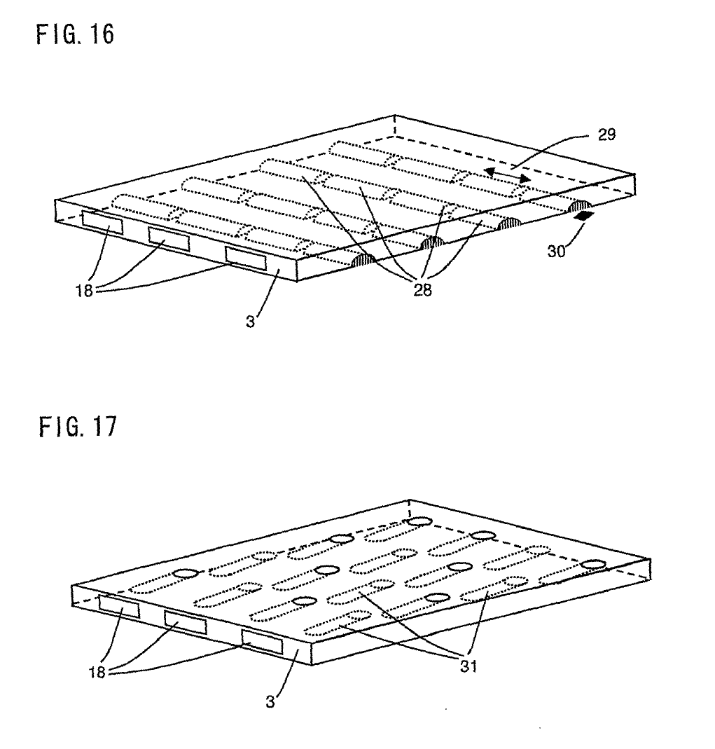

The phosphor extraction features may be divided into discrete sections, as denoted by 28 in FIG. 16. The orientation of phosphor extraction feature shown in FIG. 16 is the same as that described in the embodiment of FIG. 9. The length of the extraction feature along the direction perpendicular to the light propagation direction should be greater than that in a direction parallel to the light propagation direction. These dimensions are marked 29 and 30 respectively in FIG. 16. This may apply to any of the above embodiments.

When the phosphor extraction feature is subdivided, it may still intersect a surface of the lightguide 3, but it is not necessary and may depend on the requirements of the application. FIG. 17 shows such a part embedded phosphor column 31, whereby some of the extraction features have an interface co-planar to the major surface of the lightguide 3, whilst others terminate inside the lightguide 3. This may apply to other orientations of the phosphor extraction features. The lightguide 3 is shown without any of the ancillary optical films that are shown in FIG. 9, for example, to aid clarity.

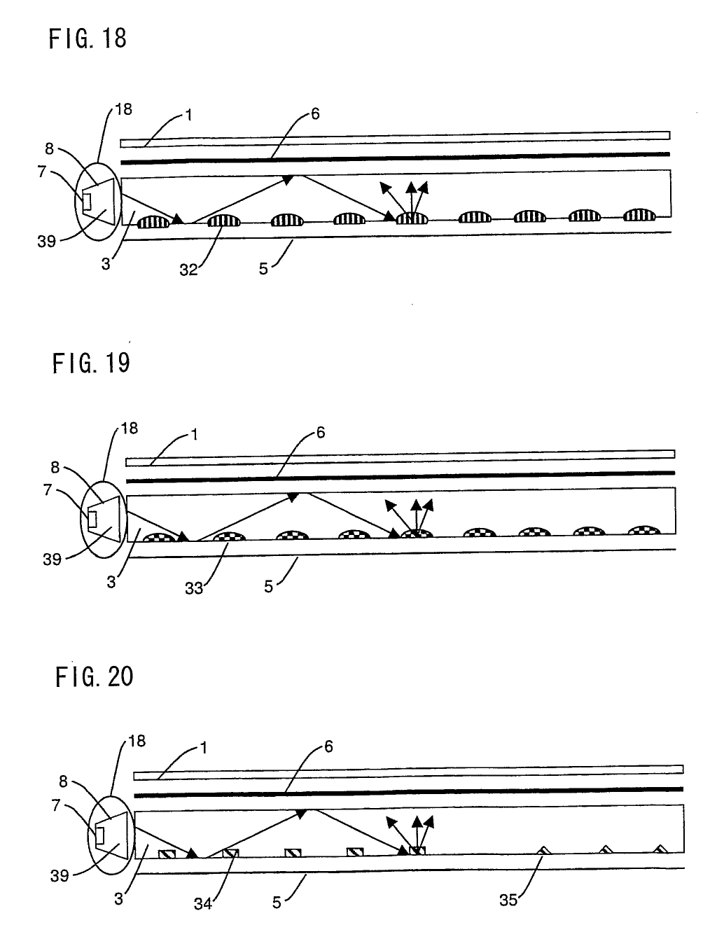

It is also possible to partially embed the phosphor medium inside the lightguide 3, but in such a way that some of the extraction feature 32 remains outside the lightguide 3, FIG. 18. In other words, the surface of one or more (and possibly all) of the combined light extraction and phosphor elements may protrude beyond the at least one of the major surfaces of the lightguide 3. This may be useful in a situation where further control of absorption of light by the phosphor and emission colour may be required, or where dimensional constraints mean that not enough phosphor may be located between the two major surfaces of the lightguide 3 to sufficiently convert the first wavelength into the second, such as the case of a very thin lightguide where the separation of the major surfaces is otherwise too small. This may apply to other embodiments.

In this embodiment the bottom part of the phosphor may be flat. The bottom surface of the phosphor medium may be substantially flat, and parallel to the major surface of the lightguide, as indicated in FIG. 18. If this is done, the substantially parallel nature of the lower surface of the phosphor medium (relative to the lower major surface of the lightguide) will ensure that TIR conditions are maintained as much as possible.

The refractive index of the resin/phosphor mixture is not limited to matching that of the lightguide material. In principle, any refractive index resin/phosphor mixture could be used.

More than one colour phosphor may be mixed in with the resin 33, FIG. 19. These may be illuminated by light from a blue light source only, or may be illuminated with light of more than one wavelength, so as to improve the efficiency of the conversion of the first wavelength into the second wavelength. For example, red, green and blue phosphors may be used with a deep blue or ultraviolet light source, although the invention is not limited to this particular combination of wavelengths and phosphors. (The term “deep blue” denotes a wavelength that is visible to the human eye, but that is at the violet-blue region of the spectrum (but is not quite UV), and will need shifting to the correct blue wavelength for display use.)

The efficiency of wavelength conversion by a phosphor is related to the degree which the wavelength is shifted by the phosphor, and reduces as the required wavelength shift increases. Thus, as an example, when the combined light extraction and phosphor elements comprise a first set having red phosphor elements and a second set having green phosphor elements, it might be preferable to generate green light from the green phosphor elements illuminated (excited) by blue light, and red light from the red phosphor elements illuminated (excited) by a yellow light source. Alternatively, the combined light extraction and phosphor elements may comprise both a red phosphor element and a green phosphor element, so that a combined light extraction and phosphor element may, when suitably illuminated, emit blue and/or yellow light.

The invention is not limited to the specific example, however, and other combinations of wavelengths and phosphors may be used, such as red, green and blue phosphors illuminated by a UV or blue light source, etc. In other words, the display may comprise at least one blue or ultraviolet source and the combined light extraction and phosphor elements may comprise first, second and third sets arranged to emit blue, green and red light when excited by ultraviolet or blue light, respectively. The number of phosphors or light sources is not limited to two and more than two phosphors and/or light sources may be used. This may apply to other embodiments.

Where a light source of the invention emits/extracts light in three (or more) wavebands, the variation with angle of intensity in each waveband may be the same or substantially the same as one another. This will ensure that the colour of the overall light vary does not vary significantly with output angle.

Alternatively, where a light source of the invention emits/extracts light in three (or more) wavebands, the variation with angle of intensity in two (or more) of these wavebands may be the same or substantially the same as one another, but may be different from the variation with angle of intensity in another waveband. This may be the case where, for example, one waveband is in a region of the spectrum in which the human eye (or other desired receptor) is not very sensitive, so that the intensity of this waveband may vary with the output angle by some degree without significantly affecting the perceived colour of the overall light output. In the case of the human eye, this may be true for a waveband in the blue/violet end of the visible spectrum or in the red end of the visible spectrum, since the human eye is less sensitive in these wavebands (the eye being most sensitive around the green region of the spectrum).

The extraction features may be made to have different cross-section, as indicated in FIG. 20. These could include but should not be limited to square, 34, or triangular, 35, etc indent profiles, giving some control over the extracted angular distribution of the light. The choice of shape may not be limited to only one per lightguide. This may apply to other embodiments.

1. An illumination panel comprising:
at least one light source arranged to emit light in at least one first waveband;
a lightguide having first and second major surfaces facing each other, and a minor edge surface through which the at least one light source is arranged to introduce light into the lightguide, the first major surface comprising an output surface for light;
and a plurality of combined light extraction and phosphor elements disposed at least partially between the first major surface and the second major surface and arranged to cause extraction of light in the lightguide through the output surface and to emit light in at least one visible second waveband, different from the at least one first waveband, when excited by light in the at least one first waveband,
wherein the combined light extraction and phosphor elements are arranged to cause extraction of light of the first waveband with a first distribution of intensity and to emit light of the second waveband with a second distribution of intensity, the variation with angle of the second distribution of intensity being equal or substantially equal to the variation with angle of the first distribution of intensity.

2. An illumination panel as claimed in claim 1 wherein the combined light extraction and phosphor elements are disposed in respective recesses, each recess being in one of the first and second major surfaces of the lightguide.

3. An illumination panel as claimed in claim 2 wherein a cross-section of the recesses is a portion of an ellipse.

4. An illumination panel as claimed in claim 3 wherein the cross-section of the recesses is half of an ellipse, the edges of each of the recesses intersecting the one of the first and second major surfaces of the lightguide at substantially 90.

5. An illumination panel as claimed in claim 2 wherein a cross-section of the recesses is rectangular.

6. An illumination panel as claimed in claim 2 wherein a cross-section of the recesses is triangular.

7. An illumination panel as claimed in claim 2 wherein the surfaces of the combined light extraction and phosphor elements define a continuous surface with the one of the first and second major surfaces of the lightguide.

8. An illumination panel as claimed in claim 2 wherein the surface of one or more of the combined light extraction and phosphor elements protrudes beyond the one of the first and second major surfaces of the lightguide.

9. An illumination panel as claimed in claim 8 wherein the surfaces of one or more of the combined light extraction and phosphor elements have a planar portion.

10. An illumination panel as claimed in claim 1 wherein the combined light extraction and phosphor elements are disposed within the lightguide.

11. An illumination panel as claimed in claim 10 wherein the combined light extraction and phosphor elements are disposed within respective cavities within the lightguide.

12. An illumination panel as claimed in claim 10 wherein the combined light extraction and phosphor elements have an elliptical cross-section.

13. An illumination panel as claimed in claim 1, in which light from the output surface is arranged to appear white.

14. An illumination panel as claimed in claim 1, in which the at least one first waveband comprises at least one visible first waveband.

15. An illumination panel as claimed in claim 14, in which the at least one visible first waveband comprises a single colour.

16. An illumination panel as claimed in claim 15, in which the single colour is blue.

17. An illumination panel as claimed in claim 16, in which the at least one visible second waveband is yellow.

18. An illumination panel as claimed in claim 16, in which the combined light extraction and phosphor elements comprise first and second sets arranged to emit red and green light, respectively, when respectively excited by yellow light and blue light.

19. An illumination panel as claimed in claim 13, in which the at least one light source comprises at least one blue or ultraviolet source and the combined light extraction and phosphor elements comprise first, second and third sets arranged to emit blue, green and red light when excited by ultraviolet or blue light, respectively.

20. An illumination panel as claimed in claim 1, in which the at least one light source comprises at least one light-emitting diode.

21. An illumination panel as claimed in claim 1, in which the at least one light source comprises at least one semiconductor laser.

22. An illumination panel as claimed in claim 1, comprising a reflector facing the second major surface.

23. A display comprising an illumination panel as defined in claim 1 disposed behind an at least partially transmissive spatial light modulator.

24. A display as claimed in claim 23, in which the spatial light modulator comprises a liquid crystal device.
